(19) United States
(12) Patent Application Publication
(10) Pub. No.: US 2008/0165642 A1
(43) Pub. Date: Jul. 10, 2008

(54) Method for evaluating optical recording medium, evaluation device, and evaluation system

(75) Inventors: Tatsuya Kato, Tokyo (JP); Yasuhiro Takagi, Tokyo (JP); Hideki Hirata, Tokyo (JP); Hajime Utsunomiya, Tokyo (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 12/003,582

(22) Filed: Dec. 28, 2007

(30) Foreign Application Priority Data
Jan. 5, 2007 (JP) 2007-319

(51) Int. Cl. G11B 20/00

(52) U.S. Cl. 369/53.1

(57) ABSTRACT

In an evaluation device and an evaluation system, the level of base power is set higher than that in an optimal recording condition at a set room temperature and lower than the level of bias power. In particular, the level of the base power is set so that the jitter value of a recording mark and a blank, which is formed in a required high temperature environment, during reproduction in the high temperature environment becomes minimum. By evaluating the recording characteristic of a recording mark and a blank formed by irradiation of recording laser light in the form of a pulse train, the recording characteristic of an optical recording medium in high-speed recording in high temperature environment is evaluated.

### BACKGROUND OF THE INVENTION

1. Field of the Invention

The present invention relates to a method for evaluating the recording characteristic of an optical recording medium in high-speed recording in high temperature environment, an evaluation device, and an evaluation system.

2. Description of the Related Art

At present, optical recording media such as CDs (compact discs), DVDs (digital versatile discs), and BDs (Blu-ray Discs: trademark) are used to record and reproduce various types of content. When these different types of optical recording media are manufactured, various evaluation parameters are determined in order to maintain the characteristics of the recording media. Recording characteristics such as the jitter value, the BER (bit error rate), and the SER (symbol error rate) are indexes that indicate whether or not information has been correctly recorded on the optical recording medium. In particular, as the demand for high-density and high-speed recording has increased in recent years, the effect of heat produced by a laser light during the recording of information on an optical recording medium has become significant.

The inventors have found that the effect of heat produced by a laser light during the recording of information on an optical recording medium differs in accordance with the environment (being the temperature environment) that is present when information is being recorded on the optical recording medium. In other words, it has been confirmed that a difference in temperature at the level of temperature environment (for example, whether the temperature of the environment where a recording device is being used is high or low, whether the temperature of the recording device itself is high or low, and the like) has an effect on the heat (being a relatively high temperature) produced by the laser light during the recording of information on the optical recording medium. Accordingly, since it is particularly important to evaluate the recording characteristics of the optical recording medium in such an operating temperature environment (being a high temperature environment) in order to maintain the quality of the optical recording medium, it has become necessary to evaluate the recording and reproduction characteristics of the optical recording medium in a high temperature environment.

Such an evaluation performed on the optical recording medium, however, brings about complications because the evaluation has to be carried out in the high temperature environment. Furthermore, there is a problem in that when not only the optical recording medium but also the recording device itself is disposed in the high temperature environment in which evaluation is to take place, it is difficult to analyze the factor of whether the temperature affects the optical recording medium or the recording device. Considering such circumstances, it is necessary to provide a method for easily measuring and evaluating the recording characteristics when the optical recording medium is used in a high temperature environment.

### SUMMARY OF THE INVENTION

In view of the foregoing problems, various exemplary embodiments of this invention provide a method, an evaluation device, and an evaluation system which can easily evaluate recording characteristics while giving consideration to the effect of heat even when high-speed recording is carried out on a high-density optical recording medium in a high temperature environment (in order to evaluate the effect of heat).

The inventors have found that the base power (Pb) margins of a jitter value, an output value, and an error value which are measured by increasing the base power (Pb) of the laser light irradiating an optical recording medium correlate with the Pb margins of a jitter value, an output value, and an error value in a high temperature environment, and that the jitter value and output value at Pb=0.4 mW in a room temperature environment (being 25° C.) correspond to recording characteristics in the high temperature environment (being 60° C.). An optical recording medium with a different cooling effect also exhibits a similar correlation, so that it has been found that the recording characteristics of an optical recording medium with a different cooling effect in the high temperature environment can be estimated from the recording characteristics of an optical recording medium in the room temperature environment.

In summary, the above-described objectives are achieved by the following embodiments of the present invention.

(1) A method for evaluating an optical recording medium having a recording layer in which a recording mark and a blank are formed by irradiation of recording laser light in the form of a pulse train with the use of at least three levels of power including a recording power, a base power, and a bias power in order to record information, the method comprising the steps of: setting the level of the base power higher than an optimal base level being the level of the base power in a set optimal recording condition, and irradiating the recording layer with the recording laser light in the form of the pulse train with the set level of the base power to obtain a recording characteristic of the recording mark and the blank formed in the recording layer and evaluate the recording characteristic.

(2) The method for evaluating an optical recording medium according to (1), wherein the set optimal recording condition is an optimal recording condition in a room temperature environment.

(3) The method for evaluating an optical recording medium according to (1) or (2), wherein the levels of the recording power and the bias power are set to be constant, and the level of the base power is increased within a range lower than the level of the bias power.

(4) The method for evaluating an optical recording medium according to any one of (1) to (3), wherein a recording mark and a blank are formed in a high temperature environment being a target on another optical recording medium identical to the optical recording medium, and a high temperature jitter value optimal base level being the level of the base power at which a high temperature jitter value being a jitter value during reproduction in the high temperature environment or a high temperature error value being an error value during reproduction in the high temperature environment becomes minimum is obtained in advance in order to set the optimal base level at the high temperature jitter value optimal base level.

(5) A method for evaluating an optical recording medium having a recording layer in which a recording mark and a blank are formed by irradiation of recording laser light in the form of a pulse train with the use of at least three levels of power including a recording power, a base power, and a bias power to record information, the method comprising the steps of: in another optical recording medium identical to the optical recording medium being targeted for evaluation, setting the level of the base power at a room temperature recording property optimal base level being the level of the base power at which a room temperature recording property being a recording property during reproduction in a room temperature environment becomes optimum, and forming a recording mark and a blank in stages in a targeted high temperature environment with gradually increasing the level of the base power from the room temperature recording property optimal base level in order to obtain a high temperature recording property of the recording mark and the blank in each stage; forming a recording mark and a blank in stages in the room temperature environment with gradually increasing the level of the base power from the room temperature recording property optimal base level in order to obtain a room temperature recording property of the recording mark and the blank in each stage; and obtaining a correlation between the high temperature recording property and a parameter about the room temperature recording property in advance, and estimating a high temperature recording property of the optical recording medium being targeted for evaluation by obtaining a parameter about a room temperature recording property of the optical recording medium being targeted for evaluation to evaluate the high temperature recording property.

(6) A method for evaluating an optical recording medium having a recording layer in which a recording mark and a blank are formed by irradiation of recording laser light in the form of a pulse train with the use of at least three levels of power including a recording power, a base power, and a bias power to record information, the method comprising the steps of: in another optical recording medium identical to the optical recording medium being targeted for evaluation, setting the level of the base power at a room temperature jitter value optimal base level being the level of the base power at which a room temperature jitter value being a jitter value during reproduction in a room temperature environment or a room temperature error value being an error value during reproduction in the room temperature environment becomes minimum, and forming a recording mark and a blank in stages in a targeted high temperature environment with gradually increasing the level of the base power from the room temperature jitter value optimal base level in order to obtain a high temperature jitter value or a high temperature error value of the recording mark and the blank in each stage; forming a recording mark and a blank in stages in the room temperature environment with gradually increasing the level of the base power from the room temperature jitter value optimal base level in order to obtain a room temperature jitter value or a room temperature error value of the recording mark and the blank in each stage; and obtaining a correlation between the high temperature jitter value or the high temperature error value and the room temperature jitter value or the room temperature error value in advance, and estimating a high temperature jitter value or a high temperature error value of the optical recording medium being targeted for evaluation by obtaining a room temperature jitter value or a room temperature error value of the optical recording medium being targeted for evaluation to evaluate the high temperature jitter value or the high temperature error value.

(7) A method for evaluating an optical recording medium having a recording layer in which a recording mark and a blank are formed by irradiation of recording laser light in the form of a pulse train with the use of at least three levels of power including a recording power, a base power, and a bias power to record information, the method comprising the steps of: in another optical recording medium identical to the optical recording medium being targeted for evaluation, setting the level of the base power at a room temperature output value optimal base level being the level of the base power at which an output value of a recording mark and a blank, formed in a room temperature environment, during reproduction in the room temperature environment becomes maximum, and forming a recording mark and a blank in stages in a high temperature environment being a target with gradually increasing the level of the base power from the room temperature output value optimal base level in order to obtain a high temperature output value being an output value of the recording mark and the blank in the high temperature environment in each stage; forming a recording mark and a blank in stages in the room temperature environment with gradually increasing the level of the base power from the room temperature output value optimal base level in order to obtain a room temperature output value of the recording mark and the blank in each stage; and obtaining a correlation between the high temperature output value and the room temperature output value in advance, and estimating a high temperature output value of the optical recording medium being targeted for evaluation by obtaining a room temperature output value of the optical recording medium being targeted for evaluation to evaluate the high temperature output value.

(8) A method for evaluating an optical recording medium having a recording layer in which a recording mark and a blank are formed by irradiation of recording laser light in the form of a pulse train with the use of at least three levels of power including a recording power, a base power, and a bias power to record information, the method comprising the steps of: in another optical recording medium identical to the targeted optical recording medium for evaluation, setting the level of the base power at a room temperature jitter value optimal base level, and forming a recording mark and a blank in stages in a high temperature environment being a target with gradually increasing the level of the base power from the room temperature jitter value optimal base level in order to obtain a high temperature jitter value or a high temperature error value of the recording mark and the blank in each stage; forming a recording mark and a blank in stages in a room temperature environment with gradually increasing the level of the base power from the room temperature jitter value optimal base level in order to obtain a room temperature jitter value or a room temperature error value of the recording mark and the blank in each stage; and obtaining a correlation between the high temperature jitter value or the high temperature error value and the margin of the level of the base power at the room temperature jitter value or the room temperature error value in advance, and estimating a high temperature jitter value or a high temperature error value of the optical recording medium being targeted for evaluation by obtaining the margin of the level of the base power at a room temperature jitter value or a room temperature error value of the optical recording medium being targeted for evaluation to evaluate the high temperature jitter value or the high temperature error value.

(9) A method for evaluating an optical recording medium having a recording layer in which a recording mark and a blank are formed by irradiation of recording laser light in the form of a pulse train with the use of at least three levels of power including a recording power, a base power, and a bias power to record information, the method comprising the steps of: in another optical recording medium identical to the optical recording medium being targeted for evaluation, setting the level of the base power at a room temperature output value optimal base level, and forming a recording mark and a blank in stages in a high temperature environment being a target with gradually increasing the level of the base power from the room temperature output value optimal base level in order to obtain a high temperature output value of the recording mark and the blank in each stage; forming a recording mark and a blank in stages in a room temperature environment with gradually increasing the level of the base power from the room temperature output value optimal base level in order to obtain a room temperature output value of the recording mark and the blank in each stage; and obtaining a correlation between the high temperature output value and the margin of the level of the base power at the room temperature output value in advance, and estimating a high temperature output value of the optical recording medium being targeted for evaluation by obtaining the margin of the level of the base power at a room temperature output value of the optical recording medium being targeted for evaluation to evaluate the high temperature output value.

(10) A method for evaluating an optical recording medium having a recording layer in which a recording mark and a blank are formed by irradiation of recording laser light in the form of a pulse train with the use of at least three levels of power including a recording power, a base power, and a bias power to record information, the method comprising the step of: in another optical recording medium identical to the optical recording medium being targeted for evaluation, setting the level of the base power at a high temperature jitter value optimal base level, obtaining a recording characteristic in advance when the base power is the high temperature jitter value optimal base power, and estimating the recording characteristic of the optical recording medium being targeted for evaluation by obtaining a high temperature jitter value optimal base level at the base power of the optical recording medium being targeted for evaluation to evaluate the recording characteristic.

(11) A device for evaluating an optical recording medium having a recording layer in which a recording mark and a blank are formed by irradiation of recording laser light in the form of a pulse train with the use of at least three levels of power including a recording power, a base power, and a bias power to record information, the device comprising: an input section for inputting a room temperature jitter value or a room temperature error value of the optical recording medium being targeted for evaluation; a memory section for storing a correlation between a high temperature jitter value or a high temperature error value and a room temperature jitter value or a room temperature error value of another optical recording medium identical to the optical recording medium being targeted for evaluation in accordance with the level of the base power of the recording laser light; an information processing section for estimating a high temperature jitter value or a high temperature error value of the optical recording medium being targeted for evaluation from the input room temperature jitter value or the input room temperature error value and the correlation in accordance with the level of the base power of the recording laser light; and a display section for displaying the estimated high temperature jitter value or the estimated high temperature error value.

(12) A system for evaluating an optical recording medium having a recording layer in which a recording mark and a blank are formed by irradiation of recording laser light in the form of a pulse train with the use of at least three levels of power including a recording power, a base power, and a bias power to record information, the system comprising: an input device including an input section for inputting a room temperature jitter value or a room temperature error value of the optical recording medium being targeted for evaluation; a memory device including a memory section for storing a correlation between a high temperature jitter value or a high temperature error value and a room temperature jitter value or a room temperature error value of another optical recording medium identical to the optical recording medium being targeted for evaluation in accordance with the level of the base power of the recording laser light; an information processing device including an information processing section for estimating a high temperature jitter value or a high temperature error value of the optical recording medium being targeted for evaluation from the inputted room temperature jitter value or the inputted room temperature error value and the correlation in accordance with the level of the base power of the recording laser light; and a display including a display section for displaying the estimated high temperature jitter value or the estimated high temperature error value.

According to the present invention, it is possible to easily evaluate the recording characteristics of a high-density optical recording medium during high-speed recording in the high temperature environment in consideration of the effect of heat. Therefore, it is possible to save time and trouble when evaluating the recording characteristics.

### BRIEF DESCRIPTION OF THE DRAWINGS

FIG. 1 is a block diagram schematically showing an evaluation device according to an exemplary embodiment of the present invention;

FIG. 2 is a block diagram schematically showing an evaluation system according to another exemplary embodiment of the present invention;

FIG. 3 is a cross-sectional side view schematically showing the entire configuration of an optical recording medium according to the exemplary embodiment of the present invention;

FIG. 4 is a graph showing the relationship between a jitter value and the level of the base power Pb of laser light in a sample A of the optical recording medium according to the exemplary embodiment of the present invention;

FIG. 5 is a graph showing the relationship between a jitter value and the level of the base power Pb of the laser light in a sample B of the optical recording medium according to the exemplary embodiment of the present invention;

FIG. 6 is a graph showing the relationship between a jitter value and the level of the base power Pb of the laser light in a sample C of the optical recording medium according to the exemplary embodiment of the present invention;

FIG. 7 is a graph showing the relationship between an output and the level of the base power Pb of the laser light in the sample A of the optical recording medium according to the exemplary embodiment of the present invention;

FIG. 8 is a graph showing the relationship between an output and the level of the base power Pb of the laser light in the sample B of the optical recording medium according to the exemplary embodiment of the present invention;

FIG. 9 is a graph showing the relationship between an output and the level of the base power Pb of the laser light in the sample C of the optical recording medium according to the exemplary embodiment of the present invention;

FIG. 10 is a graph showing the relationship between a recording characteristic and the level of the base power Pb of the laser light in the sample A of the optical recording medium according to the exemplary embodiment of the present invention;

FIG. 11 is a graph showing the relationship between a recording characteristic and the level of the base power Pb of the laser light in the sample B of the optical recording medium according to the exemplary embodiment of the present invention; and

FIG. 12 is a graph showing the relationship between a recording characteristic and the level of the base power Pb of the laser light in the sample C of the optical recording medium according to the exemplary embodiment of the present invention.

### DETAILED DESCRIPTION OF THE PREFERRED EMBODIMENTS

Exemplary embodiments of the present invention will now be described in detail with reference to the accompanying drawings.

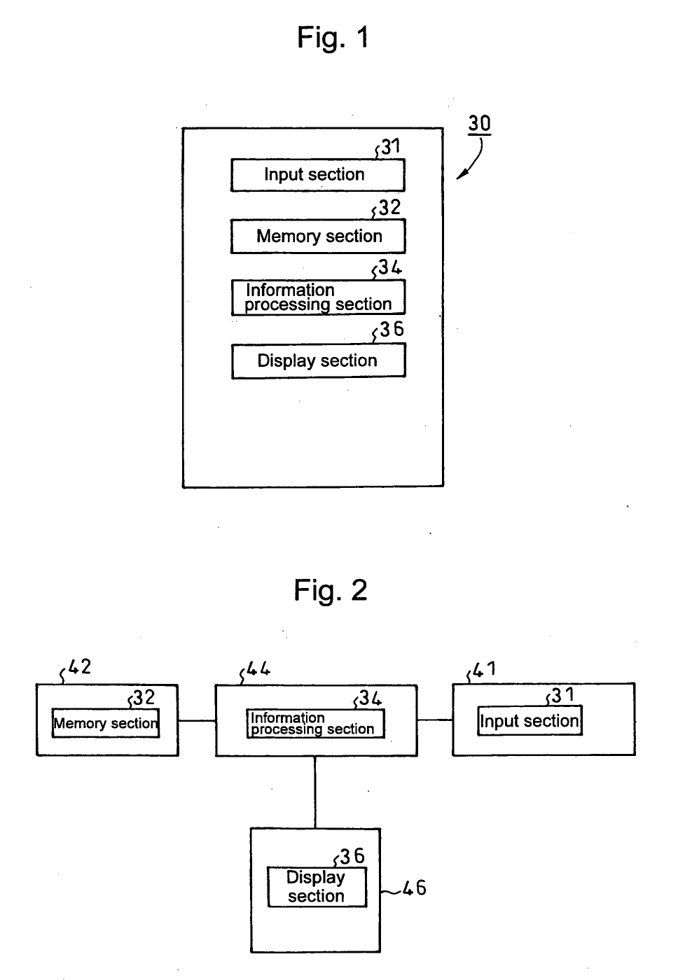

With reference to FIG. 1, an evaluation device 30 according to one exemplary embodiment of the present invention is configured to include an input section 31, a memory section 32, an information processing section 34, and a display section 36.

The input section 31 supplies the room temperature jitter value or room temperature error value of an optical recording medium being targeted for evaluation to the information processing section 34. The optical recording medium being targeted for evaluation is identical to an optical recording medium forming a standard (hereinafter called a standard optical recording medium), where the recording characteristics such as a jitter value are stored in advance on the memory section 32 (to be described later). By irradiating a recording layer with a recording laser light in the form of a pulse train using at least three levels of power, that is, a recording power Pw, a base power Pb, and a bias power Pe, a recording mark and blanks are formed in the recording layer so that information can be recorded on the optical recording medium.

The room temperature jitter value is a jitter value obtained in the case where information is recorded and reproduced in a room temperature environment on and from recording marks and blanks formed in that room temperature environment. The room temperature error value is an error value obtained in the case where information is recorded and reproduced in the room temperature environment on and from the recording marks and the blanks formed in that room temperature environment. A high temperature jitter value (to be described later) is a jitter value obtained in the case where information is recorded and reproduced in the high temperature environment on and from recording marks and blanks formed in that high temperature environment. A high temperature error value is an error value obtained in the case where information is recorded and reproduced in the high temperature environment on and from the recording marks and the blanks formed in that high temperature environment.

The memory section 32 stores the correlation between the high temperature jitter value or the high temperature error value and the room temperature jitter value or the room temperature error value of the standard optical recording medium in relation to the level of the base power of the laser light used during recording and supplies it to the information processing section 34. The pulse train of the laser light is an ejection pulse train. The correlation may be a diagram represented by, for example, a line graph or may be a database containing each individual value. In either case, the larger the number of samples stored in advance, the more precisely the optical recording medium can be evaluated. Furthermore, the correlation used may be either of the correlation between the high temperature jitter value and the room temperature jitter value or between the high temperature error value and the room temperature error value. Alternatively, both the correlations may be used to evaluate the optical recording medium in a comprehensive manner.

The information processing section 34 estimates the high temperature jitter value or high temperature error value of another identical optical recording medium being targeted for evaluation from the room temperature jitter value supplied by the input section 31 and the correlation between the high temperature jitter value or the high temperature error value and the room temperature jitter value or the room temperature error value of the standard optical recording medium supplied by the memory section 32 in accordance with the level of the base power of the laser-light used during recording, and supplies it to the display section 36.

The display section 36 displays the high temperature jitter value supplied by the information processing section 34.

The high temperature jitter value or the high temperature error value and the room temperature jitter value or the room temperature error value of the standard optical recording medium are measured in advance by a measurement device (not illustrated) and are stored in the memory section 32. When the high temperature jitter value or high temperature error value of the optical recording medium being targeted for evaluation is measured, as in the case of measuring the room temperature jitter value or the room temperature error value of the standard optical recording medium in advance, recording marks and blanks are formed in the optical recording medium being targeted for evaluation. Then, the recording marks and blanks are reproduced in the room temperature environment in order to obtain the room temperature jitter value or room temperature error value of the optical recording medium being targeted for evaluation.

When the room temperature jitter value is inputted to the input section 31, the input section 31 supplies the room temperature jitter value of the optical recording medium being targeted for evaluation to the information processing section 34. The memory section 32 supplies the correlation between the high temperature jitter value or the high temperature error value and the room temperature jitter value or the room temperature error value of the standard optical recording medium stored in advance to the information processing section 34. The information processing section 34 estimates both the high temperature jitter value or high temperature error value of the optical recording medium being targeted for evaluation from the room temperature jitter value of the optical recording medium being targeted for evaluation supplied by the input section 31 and the correlation between the high temperature jitter value or the high temperature error value and the room temperature jitter value or the room temperature error value of the standard optical recording medium supplied by the memory section 32, and supplies the high temperature jitter value or high temperature error value of the optical recording medium being targeted for evaluation to the display section 36. The display section 36 displays the high temperature jitter value or high temperature error value of the optical recording medium being targeted for evaluation supplied by the information processing section 34. Evaluating the high temperature jitter value or high temperature error value of the optical recording medium being targeted for evaluation makes it possible to evaluate the recording characteristic of the optical recording medium being targeted for evaluation in the high temperature environment.

It should be appreciated that the input section 31, the memory section 32, the information processing section 34, and the display section 36 may be independent of one another. For example, as shown in FIG. 2, the input section 31 may be installed in an input device 41, the memory section 32 may be installed in a memory device 42, the information processing section 34 may be installed in an information processing device 44, and the display section 36 may be installed in a display 46. Connecting the input device 41, the memory device 42, and the display 46 to the information processing device 44 makes it possible to compose an evaluation system of an optical recording medium.

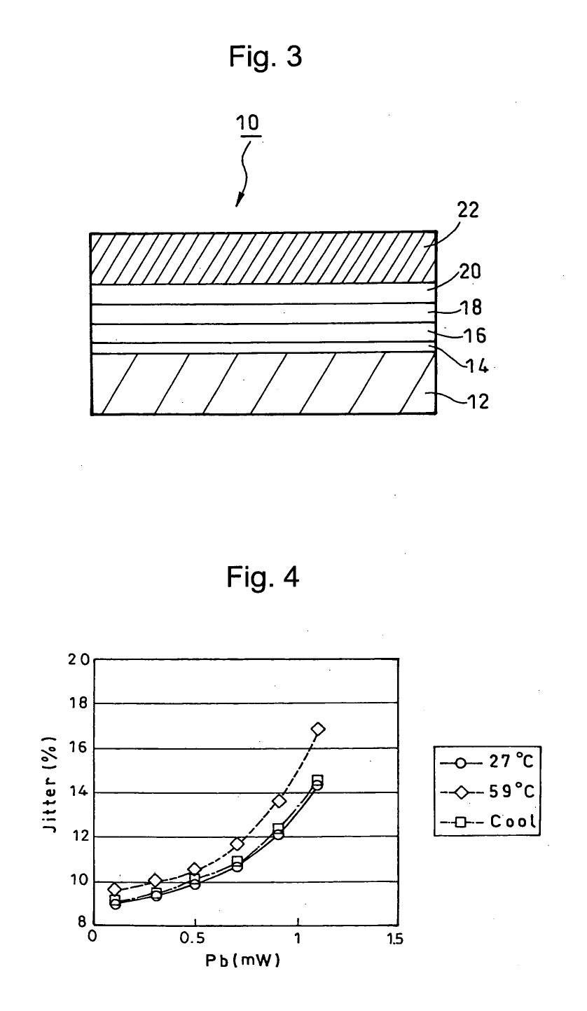

FIG. 3 shows an optical recording medium 10 which is evaluated by an evaluation method according to a first exemplary embodiment of the present invention. The optical recording medium 10 has a reflective layer 14, a second dielectric layer 16, a recording layer 18, a first dielectric layer 20, and a light transmission layer 22 which are laminated in this order on a substrate 12. Laser light is incident from the light transmission layer 22.

The substrate 12 is made of, for example, polycarbonate (PC) and has a groove pitch of 0.32 μm. The reflective layer 14 contains Ag or an Ag alloy. The first and second dielectric layers may have a single layer structure or a laminated layer structure composed of a plurality of dielectric layers. The materials forming the first and second dielectric layers are not particularly limited, but it is preferable to use oxide, nitride, sulfide, or carbide of Si, Al, Ta, or Zn such as SiO₂, Si₃O₄, Al₂O₃, AlN, TaO, ZnS, and CeO₂, or a mixture thereof. The recording layer 18 is made of a phase change material in this instance, and data is recorded thereon by taking advantage of the difference in reflectivity of the phase change material in a crystalline state and in an amorphous state. The actual material is also not particularly limited, but it is preferable that it be formed from a material in the SbTe system. As a SbTe system material, only SbTe is available. Alternatively, InSbTeGe, AgInSbTe, AgSbTeGe, AgInSbTeGe, and the like in which In, Te, Ge, Ag, and the like are added to the SbTe system as additives are also available. Three different kinds of samples were manufactured as the samples of the optical recording medium with a different cooling effect.

In sample A, the reflective layer 14 includes a reflective film made of an AgPdCu alloy. The second dielectric layer 16 is made of SiO₂:ZnS (50:50 mol %). The first dielectric layer 20 is made of AlN.

In sample B, the reflective layer 14 includes a reflective film made of an AgPdCu alloy. The second dielectric layer 16 is made of CeO₂. The first dielectric layer 20 is made of Al₂O₃.

In sample C, the reflective layer 14 includes a reflective film made of an AgPdCu alloy. The second dielectric layer 16 is made of SiO₂:ZnS (50:50 mol %). The first dielectric layer 20 is made of Al₂O₃.

In these samples, the cooling effect of sample B is better than that of sample C, and the cooling effect of sample A is better than that of sample B.

These samples were heated by a heater and recording characteristics were evaluated in the high temperature environment while the temperature was controlled using a non-contact thermometer. The recording speed was double speed (9.84 m/s) and recording was carried out at room temperature (25° C.) and at high temperature (60° C.).

A 1.7PP (peak to peak) value modulation method which was effective for high density recording was adopted, and the minimum mark of a (1.7) RLL (run length limited) character was 2T. T is a one-clock period and in this instance, T=15.15 ns. The standard recording linear velocity was 4.92 m/s, and the minimum mark length was 0.149 μm. In a recording optical system, the NA (numerical aperture) of an objective lens used was 0.85, and a recording laser wavelength used was 405 nm. It should be noted that λ/NA≦700 holds for the high density recording of the present invention.

The ejection state (being the setting of pulse number, the pulse width of each pulse, and a pulse interval) of the laser light for forming each recording mark is called a recording strategy. In the present exemplary embodiment, a signal was recorded in a predetermined position of the recoding layer on samples A, B, and C of the optical recording medium using an optimal recording strategy, and jitter values in recording and reproduction were adjusted so as to become optimal. In a similar manner, the level of the recording power Pw and the level of the bias power Pe were adjusted so that the jitter values in recording and reproduction became optimal.

To evaluate the recording characteristics, there is a method in which, for example, the recording mark is reproduced by irradiation of the laser light at the level of the reproduction power Pr and the jitter value of the reproduction signal obtained is then evaluated.

The jitter value which was measured by a time interval analyzer was a deviation from the edge of the recording mark and the standard position of the clock when the signal was read out by irradiating the recording mark and the blank with laser light set at the level of the reproduction power Pr.

If the level of the bias power Pe is too high, accumulated heat causes degradation in a jitter value at the front end of the recording mark so that the minimum recording mark becomes small. If the level of the base power Pb is too high, accumulated heat makes the recording mark small. Accordingly, by combining the level of the recording power Pw, the level of the bias power Pe, and the level of the base power Pb which are optimal to the medium, an optimal recording condition is obtained which minimizes the jitter value.

When the recording characteristic in the high temperature environment is evaluated at room temperature, for example, the level of the recording power Pw is fixed on another optical recording medium which is identical to the optical recording medium being targeted for evaluation, and the level of the base power Pb is set so as to minimize the room temperature jitter value. Then, a signal is recorded while gradually increasing the level of the base power Pb in the targeted high temperature environment and the room temperature environment. The upper limit of the level of the base power Pb is lower than the level of the bias power Pe. This is because if the level of the base power Pb is greater than or equal to the level of the bias power Pe, a predetermined area of the targeted recording layer is rapidly cooled and hence cannot be changed from a crystalline state into an amorphous state.

The correlation between the high temperature jitter value and the room temperature jitter value obtained at this time is obtained in advance. The correlation may be provided as a graph like, for example, that shown in FIG. 4 or may be provided as a database containing each individual value, as described above. By obtaining the room temperature jitter value of the optical recording medium being targeted for evaluation, the high temperature jitter value of the optical recording medium being targeted for evaluation is estimated from the correlation represented by the graph or a table, and by evaluating the high temperature jitter value, it is possible to evaluate the recording characteristic in the high temperature environment.

Otherwise, as described above, a diagram represented by a line graph or a database may be stored in the evaluation device. By obtaining the room temperature jitter value of the optical recording medium being targeted for evaluation, the high temperature jitter value of the optical recording medium being targeted for evaluation can be obtained by the correlation represented by the stored graph or the like.

In this instance, an output value may be used as the recording characteristic instead of the jitter value. The correlation between the margin of the level of the base power of the laser light of a room temperature jitter value and a high temperature jitter value on another optical recording medium which is identical to the optical recording medium being targeted for evaluation is obtained in advance. Then, the high temperature jitter value of the optical recording medium being targeted for evaluation may be estimated from the margin of the level of the base power of the laser light of the room temperature jitter value of the optical recording medium being targeted for evaluation. Also in this method, an output value is available instead of the jitter value.

Furthermore, the level (hereinafter called a high temperature jitter value optimal base level) of the base power of the laser light at which the high temperature jitter value is minimized may be obtained on another optical recording medium identical to the optical recording medium being targeted for evaluation. Furthermore, a recording characteristic at the high temperature jitter value optimal base level may be obtained in advance. Then, the recording characteristic of the optical recording medium being targeted for evaluation in the high temperature environment may be estimated from the high temperature jitter value optimal base level of the base power of the laser light of the optical recording medium being targeted for evaluation.

In the present exemplary embodiment, a jitter value (Jitter), an output (PP value), and a difference in the jitter values (Δjitter) are adopted as recording characteristics. FIGS. 4 to 12 show the results.

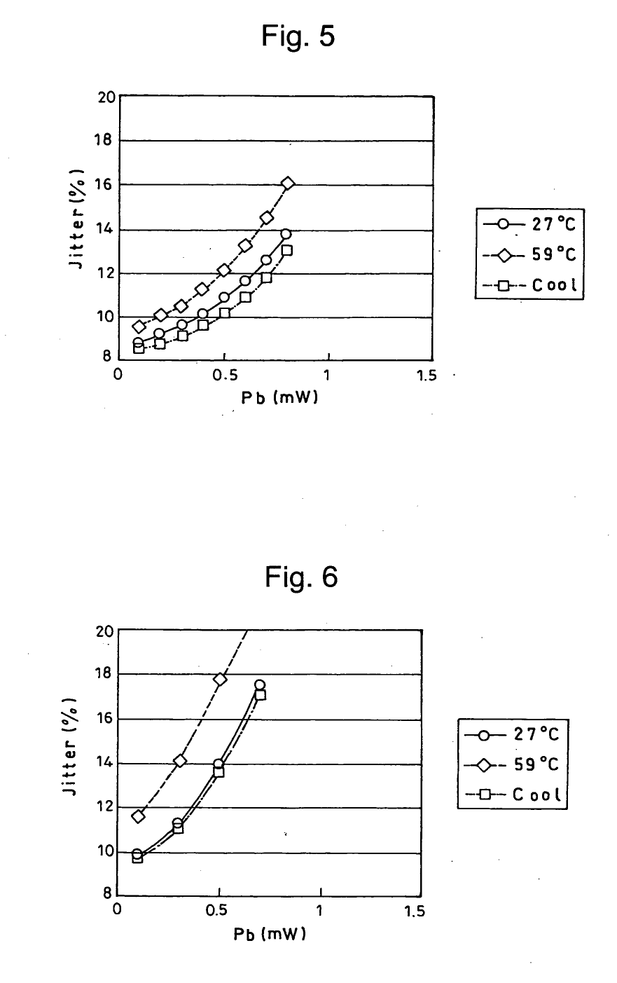

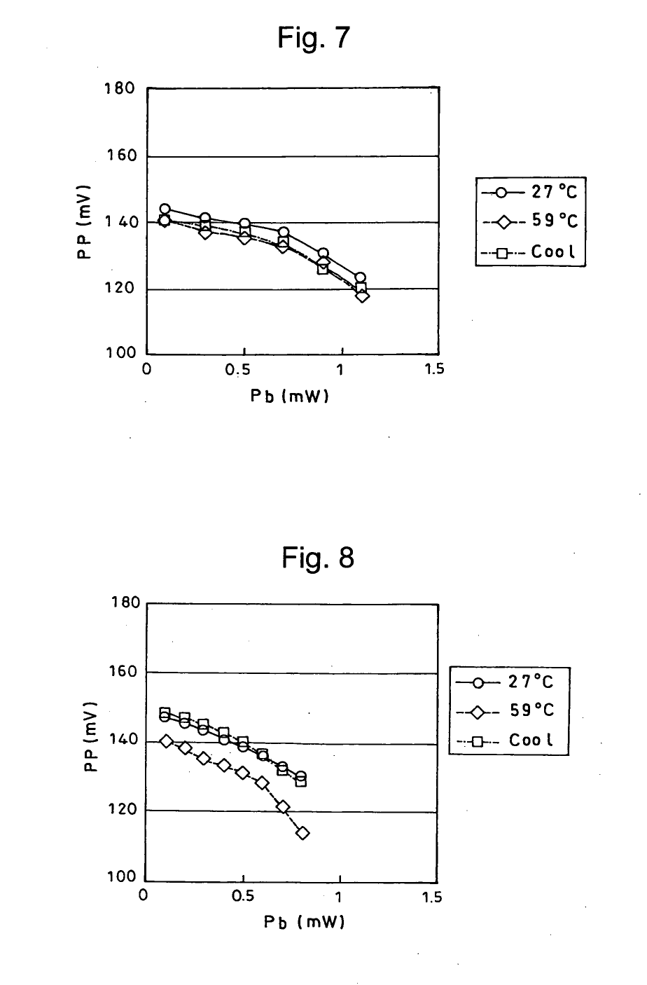

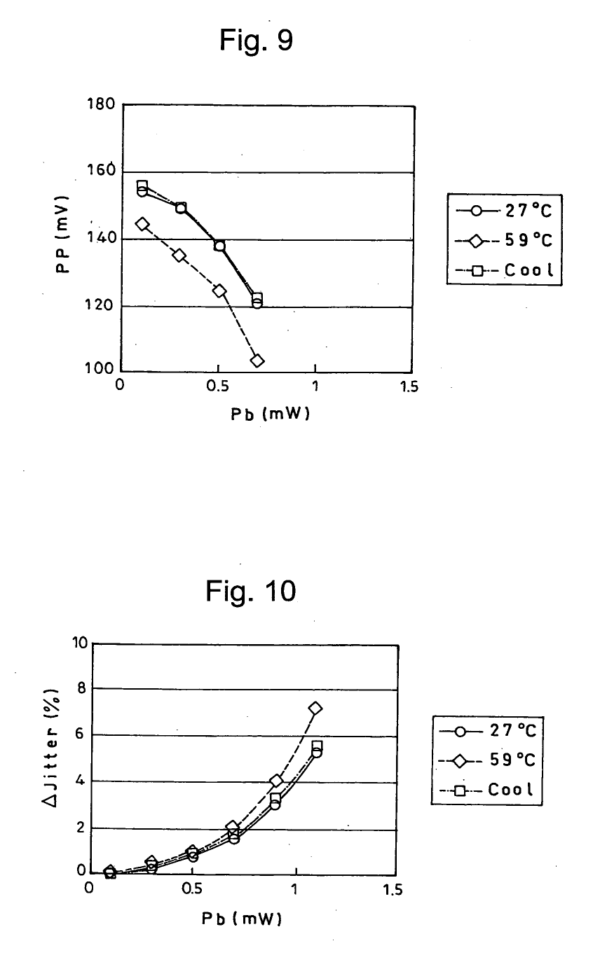

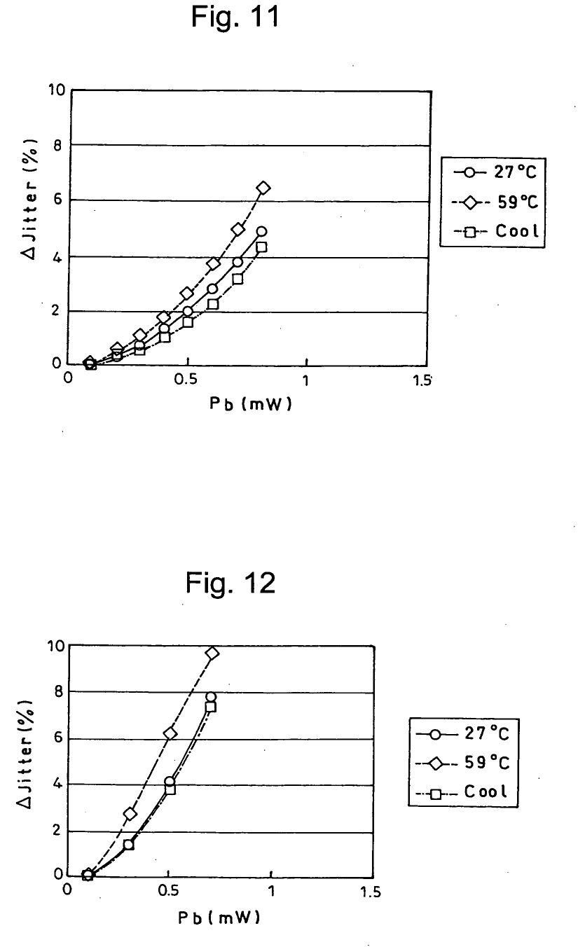

With respect to the jitter value, FIG. 4 shows the case of sample A, FIG. 5 shows the case of sample B, and FIG. 6 shows the case of sample C. With respect to the PP value, FIG. 7 shows the case of sample A, FIG. 8 shows the case of sample B, and FIG. 9 shows the case of sample C. With respect to the difference in the jitter values, FIG. 10 shows the case of sample A, FIG. 11 shows the case of sample B, and FIG. 12 shows the case of sample C.

As is apparent from FIGS. 4 to 12, the recording characteristics of the high temperature jitter value and output value are degraded in the high temperature environment (60° C.) in every sample with the different cooling effect. The room temperature jitter value and output value when the level of the base power Pb in the room temperature environment (25° C.) is 0.4 mW coincide with the recording characteristics in the high temperature environment (60° C.).

It is also found that the margin of the level of the base power Pb in the room temperature environment (25° C.) tends to reduce with reduction in the rapid cooling effect. Furthermore, it is apparent from FIGS. 6, 9, and 12 that the degree of deterioration in each of the high temperature jitter value, the PP value, and the difference in the jitter values with respect to increase in the level of the base power Pb tends to increase during recording in the high temperature environment (60° C.).

In particular, it is conceivable that the cause of the increase in the degree of reduction in the PP value with respect to the increase in the level of the base power Pb is due to the effect of self-erase.

As is known from FIGS. 4 to 6, the jitter values obtained during recording in the room temperature environment (25° C.), during recording in the high temperature environment (60° C.), and during recording in cool environment are increased with an increase in the level of the base power Pb of the laser light, and the jitter values show a correlation. Therefore, it is possible to estimate a high temperature jitter value when recording in the high temperature environment (60° C.) from a room temperature jitter value obtained during recording in the room temperature environment (25° C.) and hence it is possible to evaluate the characteristic of an optical recording medium in the high temperature environment.

As is known from FIGS. 7 to 9, the PP values obtained during recording in the room temperature environment (25° C.), in the high temperature environment (60° C.), and in the cool environment are decreased with an increase in the level of the base power Pb of the laser light and show a correlation. Therefore, it is possible to estimate a PP value when recording in the high temperature environment (60° C.) from a PP value obtained during recording in the room temperature environment (25° C.) and hence it is possible to evaluate the characteristic of an optical recording medium in the high temperature environment.

As is known from FIGS. 4 to 6, in FIG. 4, for example, the margin of the level of the base power Pb of the laser light at which the jitter value becomes 10% or less is approximately 0.5 mW or less when recording in the room temperature environment (25° C.) and in the cool environment and is approximately 0.3 mW or less when recording in the high temperature environment (60° C.). In FIG. 5, in a similar manner, the margin is approximately 0.4 mW or less when recording in the room temperature environment (25° C.), is approximately 0.5 mW or less when recording in the cool environment, and is approximately 0.2 mW or less when recording in the high temperature environment (60° C.). In FIG. 6, for example, the margin of the level of the base power Pb of the laser light at which the jitter value becomes 14% or less is approximately 0.5 mW or less when recording in the room temperature environment (25° C.) and in the cool environment and is approximately 0.3 mW or less when recording in the high temperature environment (60° C.).

Therefore, it is possible to estimate the margin of the level of the base power of laser light at a high temperature jitter value when recording in the high temperature environment (60° C.) from the margin of the level of the base power of the laser light of a room temperature jitter value obtained during recording in the room temperature environment (25° C.) in order to evaluate that characteristic of an optical recording medium.

Also, in FIG. 7, for example, the margin of the level of the base power Pb of the laser light at which the PP value becomes 140 mV or more is approximately 0.5 mW or less when recording in all the environments, being the room temperature environment (25° C.), the cool environment, and the high temperature environment (60° C.). In a similar manner, with reference to FIG. 8, the margin is approximately 0.5 mW or less when recording in the room temperature environment (25° C.) and in the cool environment, and is approximately 0.2 mW or less when recording in the high temperature environment (60° C.). In FIG. 9, in a similar manner, the margin is approximately 0.5 mW or less when recording in the room temperature environment (25° C.) and in the cool environment, and is approximately 0.2 mW or less when recording in the high temperature environment (60° C.).

Therefore, the margin of the level of the base power of laser light at a PP value when recording in the high temperature environment (60° C.) can be estimated from the margin of the level of the base power of the laser light at a PP value in recording obtained during the room temperature environment (25° C.), so that it is possible to evaluate that characteristic of an optical recording medium.

Furthermore, with reference to FIG. 10, for example, the margin of the level of the base power Pb of the laser light at which the Δjitter becomes 2% or less is approximately 0.7 mW or less when recording in all the environments, being the room temperature environment (25° C.), the cool environment, and the high temperature environment (60° C.). In FIG. 9, in a similar manner, the margin is approximately 0.5 mW or less when recording in the room temperature environment (25° C.) and in the cool environment, and is approximately 0.4 mW or less when recording in the high temperature environment (60° C.). In FIG. 12, the margin of the level of the base power Pb of the laser light at which the ΔJitter becomes 4% or less is approximately 0.5 mW or less when recording in the room temperature environment (25° C.) and in the cool environment, and is approximately 0.4 mW or less when recording in the high temperature environment (60° C.).

Furthermore, it is also possible to evaluate an optical recording medium by another recording characteristic obtained during recording in the room temperature environment (25° C.) in addition to the aforementioned jitter value and PP value. In particular, the inventors have confirmed that there is a correlation between the jitter value and an error value (SER or BER). While detailed data is not described here, it has been confirmed by experiment that an optical recording medium can be evaluated using the error value instead of the jitter value.

The present exemplary embodiments use the case of the rewritable optical recording medium as an example with which to describe the present invention, however, it should be appreciated that the aforementioned recording strategy is applicable to a write-once read-multiple type of optical recording medium. It has also been separately confirmed that the contents of the present invention are useful in the write-once read-multiple type of optical recording medium. The present invention is applicable to an optical recording medium which can adopt the aforementioned recording strategy, irrespective of the composition of the recording medium.

What is claimed is:

1. A method for evaluating an optical recording medium having a recording layer in which a recording mark and a blank are formed by irradiation of recording laser light in the form of a pulse train with the use of at least three levels of power including a recording power, a base power, and a bias power in order to record information, the method comprising the steps of:
setting the level of the base power higher than an optimal base level being the level of the base power in a set optimal recording condition, and irradiating the recording layer with the recording laser light in the form of the pulse train with the set level of the base power to obtain a recording characteristic of the recording mark and the blank formed in the recording layer and evaluate the recording characteristic.

2. The method for evaluating an optical recording medium according to claim 1, wherein
the set optimal recording condition is an optimal recording condition in a room temperature environment.

3. The method for evaluating an optical recording medium according to claim 1, wherein
the levels of the recording power and the bias power are set to be constant, and the level of the base power is increased within a range lower than the level of the bias power.

4. The method for evaluating an optical recording medium according to claim 2, wherein
the levels of the recording power and the bias power are set to be constant, and the level of the base power is increased within a range lower than the level of the bias power.

5. The method for evaluating an optical recording medium according to claim 1, wherein
a recording mark and a blank are formed in a high temperature environment being a target on another optical recording medium identical to the optical recording medium, and a high temperature jitter value optimal base level being the level of the base power at which a high temperature jitter value being a jitter value during reproduction in the high temperature environment or a high temperature error value being an error value during reproduction in the high temperature environment becomes minimum is obtained in advance in order to set the optimal base level at the high temperature jitter value optimal base level.

6. The method for evaluating an optical recording medium according to claim 2, wherein
a recording mark and a blank are formed in a high temperature environment being a target on another optical recording medium identical to the optical recording medium, and a high temperature jitter value optimal base level being the level of the base power at which a high temperature jitter value being a jitter value during reproduction in the high temperature environment or a high temperature error value being an error value during reproduction in the high temperature environment becomes minimum is obtained in advance in order to set the optimal base level at the high temperature jitter value optimal base level.

7. The method for evaluating an optical recording medium according to claim 3, wherein
a recording mark and a blank are formed in a high temperature environment being a target on another optical recording medium identical to the optical recording medium, and a high temperature jitter value optimal base level being the level of the base power at which a high temperature jitter value being a jitter value during reproduction in the high temperature environment or a high temperature error value being an error value during reproduction in the high temperature environment becomes minimum is obtained in advance in order to set the optimal base level at the high temperature jitter value optimal base level.

8. The method for evaluating an optical recording medium according to claim 4, wherein
a recording mark and a blank are formed in a high temperature environment being a target on another optical recording medium identical to the optical recording medium, and a high temperature jitter value optimal base level being the level of the base power at which a high temperature jitter value being a jitter value during reproduction in the high temperature environment or a high temperature error value being an error value during reproduction in the high temperature environment becomes minimum is obtained in advance in order to set the optimal base level at the high temperature jitter value optimal base level.

9. A method for evaluating an optical recording medium having a recording layer in which a recording mark and a blank are formed by irradiation of recording laser light in the form of a pulse train with the use of at least three levels of power including a recording power, a base power, and a bias power to record information, the method comprising the steps of:
in another optical recording medium identical to the optical recording medium being targeted for evaluation, setting the level of the base power at a room temperature recording property optimal base level being the level of the base power at which a room temperature recording property being a recording property during reproduction in a room temperature environment becomes optimum, and forming a recording mark and a blank in stages in a targeted high temperature environment with gradually increasing the level of the base power from the room temperature recording property optimal base level in order to obtain a high temperature recording property of the recording mark and the blank in each stage;
forming a recording mark and a blank in stages in the room temperature environment with gradually increasing the level of the base power from the room temperature recording property optimal base level in order to obtain a room temperature recording property of the recording mark and the blank in each stage; and
obtaining a correlation between the high temperature recording property and a parameter about the room temperature recording property in advance, and estimating a high temperature recording property of the optical recording medium being targeted for evaluation by obtaining a parameter about a room temperature recording property of the optical recording medium being targeted for evaluation to evaluate the high temperature recording property.

10. The method for evaluating an optical recording medium according to claim 9, wherein the room temperature recording property is a room temperature jitter value being a jitter value during reproduction in a room temperature environment or a room temperature error value being an error value during reproduction in the room temperature environment, and
the room temperature recording property optimal base level is a room temperature jitter value optimal base level being the level of the base power at which the room temperature jitter value or the room temperature error value becomes minimum, and
the high temperature recording property is a high temperature jitter value being a jitter value during reproduction in the high temperature environment or a high temperature error value being an error value during reproduction in the high temperature environment, and
the parameter is the room temperature jitter value or the room temperature error value.

11. The method for evaluating an optical recording medium according to claim 9, wherein
the room temperature recording property is a room temperature output value being an output value of a recording mark and a blank, formed in a room temperature environment, during reproduction in the room temperature environment, and
the room temperature recording property optimal base level is a room temperature output value optimal base level being the level of the base power at which the room temperature output value becomes maximum, and
the high temperature recording property is a high temperature output value being an output value of a recording mark and a blank, formed in a high temperature environment, during reproduction in the high temperature environment, and
the parameter is the room temperature jitter value or the room temperature error value.

12. The method for evaluating an optical recording medium according to claim 9, wherein
the room temperature recording property is a room temperature jitter value or a room temperature error value, and
the room temperature recording property optimal base level is a room temperature jitter value optimal base level, and
the high temperature recording property is a high temperature jitter value or a high temperature error value, and
the parameter is the margin of the level of the base power at the room temperature jitter value or the room temperature error value.

13. The method for evaluating an optical recording medium according to claim 9, wherein
the room temperature recording property is a room temperature output value, and
the room temperature recording property optimal base level is a room temperature output value optimal base level, and
the high temperature recording property is a high temperature output value, and
the parameter is the margin of the level of the base power at the room temperature output value.

14. A method for evaluating an optical recording medium having a recording layer in which a recording mark and a blank are formed by irradiation of recording laser light in the form of a pulse train with the use of at least three levels of power including a recording power, a base power, and a bias power to record information, the method comprising the step of:
in another optical recording medium identical to the optical recording medium being targeted for evaluation, setting the level of the base power at a high temperature jitter value optimal base level, obtaining a recording characteristic in advance when the base power is the high temperature jitter value optimal base power, and estimating the recording characteristic of the optical recording medium being targeted for evaluation by obtaining a high temperature jitter value optimal base level at the base power of the optical recording medium being targeted for evaluation to evaluate the recording characteristic.

15. A device for evaluating an optical recording medium having a recording layer in which a recording mark and a blank are formed by irradiation of recording laser light in the form of a pulse train with the use of at least three levels of power including a recording power, a base power, and a bias power to record information, the device comprising:
an input section for inputting a room temperature jitter value or a room temperature error value of the optical recording medium being targeted for evaluation;
a memory section for storing a correlation between a high temperature jitter value or a high temperature error value and a room temperature jitter value or a room temperature error value of another optical recording medium identical to the optical recording medium being targeted for evaluation in accordance with the level of the base power of the recording laser light;
an information processing section for estimating a high temperature jitter value or a high temperature error value of the optical recording medium being targeted for evaluation from the input room temperature jitter value or the input room temperature error value and the correlation in accordance with the level of the base power of the recording laser light; and
a display section for displaying the estimated high temperature jitter value or the estimated high temperature error value.

16. A system for evaluating an optical recording medium having a recording layer in which a recording mark and a blank are formed by irradiation of recording laser light in the form of a pulse train with the use of at least three levels of power including a recording power, a base power, and a bias power to record information, the system comprising:
an input device including an input section for inputting a room temperature jitter value or a room temperature error value of the optical recording medium being targeted for evaluation;
a memory device including a memory section for storing a correlation between a high temperature jitter value or a high temperature error value and a room temperature jitter value or a room temperature error value of another optical recording medium identical to the optical recording medium being targeted for evaluation in accordance with the level of the base power of the recording laser light;
an information processing device including an information processing section for estimating a high temperature jitter value or a high temperature error value of the optical recording medium being targeted for evaluation from the inputted room temperature jitter value or the inputted room temperature error value and the correlation in accordance with the level of the base power of the recording laser light; and
a display including a display section for displaying the estimated high temperature jitter value or the estimated high temperature error value.
